(19) United States
(12) Patent Application Publication
(10) Pub. No.: US 2023/0228833 A1
(43) Pub. Date: Jul. 20, 2023

(54) SYSTEMS AND METHODS CONFIGURED TO ENABLE POSITIONAL AND QUANTITATIVE ANALYSIS OF NOISE EMISSIONS IN A TARGET AREA

(71) Applicant: Spoke Acoustics Pty Ltd, Queenscliff (AU)

(72) Inventor: Simon Kean, Queenscliff (AU)

(21) Appl. No.: 18/001,958

(22) PCT Filed: Jun. 15, 2021
(86) PCT No.: PCT/AU2021/050618

§ 371 Date: Dec. 15, 2022

(30) Foreign Application Priority Data
Jun. 15, 2020 (AU) 2020901976

(51) Int. Cl. G01S 3/808; G01S 5/20

(52) U.S. Cl. CPC G01S 3/8083; G01S 5/20

(57) ABSTRACT

Technology relates to positional and quantitative analysis of noise emissions in a target area. Some embodiments have been developed to allow for triangulation of noise sources, thereby to assist in understanding noise levels originating from within the target area. While some embodiments will be described herein with particular reference to those applications, it will be appreciated that the present disclosure is not limited to such a field of use, and is applicable in broader contexts.

### CROSS-REFERENCE TO RELATED APPLICATIONS

This application is a national phase entry under 35 U.S.C. § 371 of International Patent Application PCT/AU2021/050618, filed Jun. 15, 2021, designating the United States of America and published as International Patent Publication WO 2021/253081 A1 on Dec. 23, 2021, which claims the benefit under Article 8 of the Patent Cooperation Treaty to Australian Patent Application Serial No. 2020901976, filed Jun. 15, 2020.

### TECHNICAL FIELD

The present disclosure relates, in various embodiments, to systems and methods configured to enable positional and quantitative analysis of noise emissions in a target area. Some embodiments have been developed to allow for triangulation of noise sources, thereby to assist in understanding noise levels originating from within the target area. While some embodiments will be described herein with particular reference to those applications, it will be appreciated that the present disclosure is not limited to such a field of use, and is applicable in broader contexts.

### BACKGROUND

Any discussion of the background art throughout the specification should in no way be considered as an admission that such art is widely known or forms part of common general knowledge in the field.

Noise monitoring equipment is often used for the purposes of monitoring noise emissions from a target area, such as a road, airport, industrial zone, or the like. For example, this is often performed to either: (i) analyze noise levels in adjoining areas, for example, residential areas, for the purposes of assessing impact on noise levels of activities in the target area; and (ii) monitor noise levels in an adjoining area, thereby to assess compliance with defined emission level regulations.

Current hardware and analysis techniques are often inaccurate, for at least the following reasons: (i) difficulties in differentiating noise from the target area with ambient noise; and (ii) false positive readings whereby noises from outside the target area may be attributed to the target area. This applies even where directional monitoring equipment is used.

### BRIEF SUMMARY

It is an object of the present disclosure to overcome or ameliorate at least one of the disadvantages of the prior art, or to provide a useful alternative.

Embodiments include systems and methods configured to enable positional and quantitative analysis of noise emissions in a target area.

Example embodiments are discussed further below in the sections entitled detailed description and claims.

Reference throughout this specification to “one embodiment,” “some embodiments” or “an embodiment” means that a particular feature, structure or characteristic described in connection with the embodiment is included in at least one embodiment of the present disclosure. Thus, appearances of the phrases “in one embodiment,” “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

FIG. 1A illustrates an example framework for a system for monitoring and analyzing noise emissions in a target region according to an embodiment of the present disclosure.

FIG. 1B is similar to FIG. 1A, but further illustrates all or a subset of the sensors of the system detecting a noise, which are described by vectors.

FIG. 1C is similar to FIGS. 1A and 1B, but further illustrates how noise may propagate in a target region from each point based on local conditions.

FIG. 2A illustrates a configuration method according to an embodiment of the present disclosure.

FIG. 2B illustrates an example prediction method according to an embodiment of the present disclosure, which may be performed using a system as configured as described with reference to FIG. 2A.

### DETAILED DESCRIPTION

Described herein is technology relating to positional and quantitative analysis of noise emissions in a target area. Some embodiments have been developed to allow for triangulation of noise sources, thereby to assist in understanding noise levels originating from within the target area. While some embodiments will be described herein with particular reference to those applications, it will be appreciated that the present disclosure is not limited to such a field of use, and is applicable in broader contexts.

In overview, technology described below is relevant particularly to environmental noise monitoring, for example, in scenarios where there is a desire to monitor noise emissions from a target region (for example, a road, industrial area, or the like). This may find application practical situations including the following:
Monitoring of noise emissions from a target region.
Verifying whether noise complaints relating to a target region in fact relate to noise emissions from within the target region.
Monitoring operation and/or movement of objects within a target region.

The term “target region” should be afforded a broad interpretation, and is generally used to functionally describe a region in which noise sources of interest are located. This is differentiated from an “impacted region,” being a region outside of the target region in which noise levels are of interest (for example, a residential area). The impacted region may or may not be adjacent the target region. In overview, an objective of embodiments of technology described herein is to provide modelled data representative of noise levels at various locations in an impacted region, which result from noise sources within the target region.

Embodiments include methods for analyzing noise emissions in a target region. These methods include a step of receiving data representative of noise readings measured by a plurality of directional noise sensor devices. For example, these devices may include (Norsonic Noise Compass Nor 1297, Svantek SV200A Sound Science BarnOwl). Each of the sensor devices has a known location and orientation. The location may be defined by GPS coordinates, or relative to a localized coordinate array. The orientation is preferably defined relative to a true north.

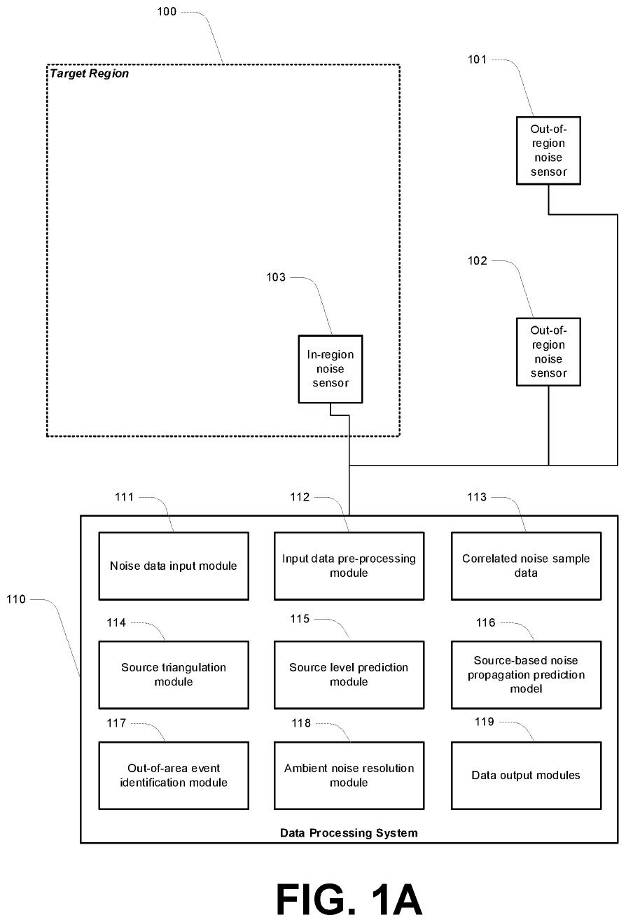

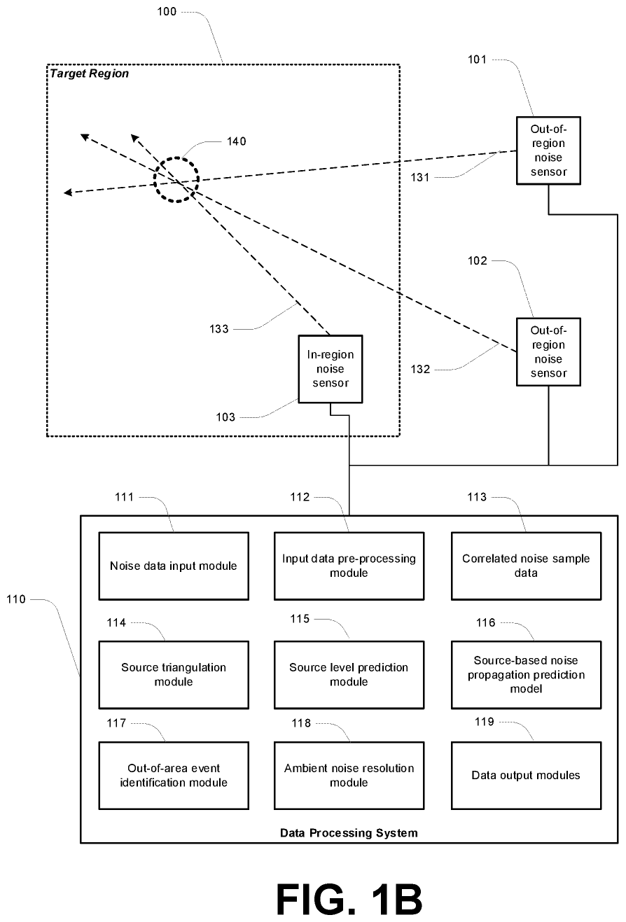

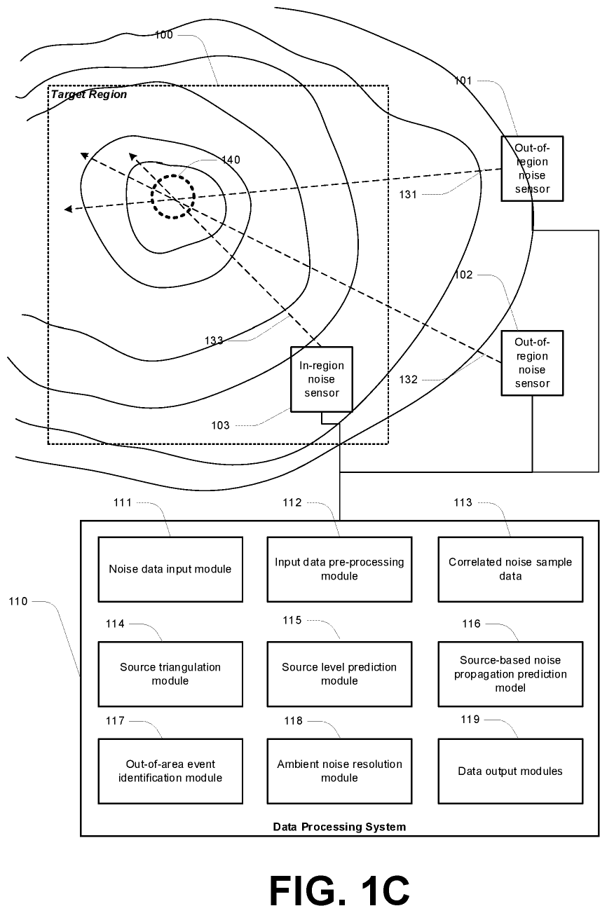

FIG. 1A illustrates an example framework according to one embodiment. A plurality of noise sensors 101, 102 and 103 are configured to monitor a target region 100. For the sake of this example, sensors 101 and 102 are “out-of-region” sensors, located outside of target region 100, and sensor 103 is an in-region sensor. However, in other examples different combinations of sensor locations may be used (e.g., all in or out of region).

Sensors 101 to 103 are coupled to a data processing system 110. System 110 includes a noise data input module 111, which is configured to receive data from the sensors, and record all or a subset of that data. The storage is managed at least in part by an input data pre-processing module 112, which performs functions including correlation of samples to common points in time. Time-correlated noise sample data 113 is stored for further processing. A source triangulation module 114 is configured to process data 113, thereby to predict a source location. Example techniques for source location prediction are described below. By way of example, as shown in FIG. 1B, all or a subset of the sensors detect a noise, which is described by a vector (see vectors 131-133). The intersection is those vectors in a two-dimensional plane defines a source location 140. Where the vectors do not intersect, that may indicate multiple sources (and an example for allowing locating of multiple sources is provided further below).

A source level prediction module 115 is configured to predict noise strength at the source location, for example, based on a spatial relationship between the source location and one or more of the sensors.

A source-based noise propagation prediction module 116 is configured to predict noise levels within the target zone based on predicted source location and strength. For example, as shown in FIG. 1C, this may model how noise propagates in the target region from each point based on local conditions (for example, topology, infrastructure, and the like).

A data output module 119 is configured to output predicted noise levels at various locations inside (and optionally outside) of target region 100.

In some embodiments, an out-of-area identification module 117 is configured to identify noises that originate outside of target region 100, and log those. Whilst the propagation model may be unable to determine how those propagate, knowledge that the source was outside of the target region may be adequate information (for example, where noise monitoring if intended to monitor specifically for above threshold noise events originating within the target region).

In some embodiments, an ambient noise resolution module 118 is configured to apply algorithms thereby to account for anticipated ambient noises observed by the sensors.

In a preferred embodiment, system 110 is configured to perform a method that includes processing the data representative of noise readings measured by the plurality of directional noise sensor devices thereby to define a plurality of point-in-time data sets. This is based on a predefined sampling protocol. The nature of the sampling protocol varies between embodiments, and may be based on any one or more of the following:
A standard sampling rate.
A variable sampling rate.
A dynamically variable sampling rate, which has at least two settings, including a background low rate setting, and a higher rate setting, which is activated for a time window during which noise levels from one or more sensors are above a threshold value.
A protocol that records samples only at times defined relative to observation of a noise level above a predefined threshold.

Each point-in-time data set includes point-in time values for each of the directional noise sensor devices at a defined point in time, including:
A noise level value. This may be defined, for example, based as a measure of sound pressure, sound intensity and/or sound power.
A direction value associated with the noise level value. For example, this may be defined as an angle defined relative to north. It will be appreciated that some known noise sensor devices are able to provide a direction reading in three dimensions; for the present embodiments it will be assumed that only two dimensional data is used. However, it will be appreciated by those skilled in the art how these two-dimensional examples may be modified to use three dimensional directional data.

In some embodiments, defining the plurality of point-in-time data includes a data pre-processing step whereby timestamps of data from local device clocks of separate sensor devices are adjusted for synchronicity, and direction values are normalized to account for individual device orientations.

An example point-in-time data set is provided below:

| | | | |
|---|---|---|---|
| Date & time | Bearing | Energy (x, y) | Total dBA |

Sensor 1

| | | | |
|---|---|---|---|
| 12:03:25 | 355 | 0.257 | 81 |
| 12:03:26 | 17 | 0.227 | 102 |
| 12:03:27 | 24 | 0.322 | 99 |

Sensor 2

| | | | |
|---|---|---|---|
| 12:03:25 | 175 | 0.515 | 85 |
| 12:03:26 | 197 | 0.454 | 103 |
| 12:03:27 | 204 | 0.645 | 102 |

The method then includes, for each or a subset of the point-in-time data sets, executing a source analysis process. In overview, in some embodiments the source analysis process includes three components:
(i) Performing a source locating process thereby to predict a noise source location. For example, this may include a triangulation method, or a vector intersection identification method. This allows for determination of whether the source of the noise is within the target region or outside of the target region, and a predicted location of the noise source within the target region.
(ii) Evaluating source location(s) against source object parameters. Examples of source object parameters include: object dimensions, object acoustic properties, and object scenes for multiple objects. In some embodiments, this makes use of additional data from cameras and/or other sensors that identify a physical noise source, and this step allows for validation that there is a plausible relationship between the source and observed noise,
(iii) Performing a source noise level prediction process thereby to predict a source noise level. This source noise level is preferably representative of a noise power level at the source. In some embodiments the source noise level may also include a directional component.

In some embodiments the source locating process is executed based on input including the direction value for each sensor device, and optionally additionally the noise level value for each sensor device. An example of how the source locating process is performed in one embodiment is provided below.

Each sensor device, ‘n’, provides a noise level vector, at time T from origin ‘o’. The geometric components may be expressed in the form below to obtain the coordinates of a potential intersection with another vector. The intersection is at an unknown distance, ‘rt,n’, from sensor ‘n’.

$$( \begin{matrix}{x}_{t , n} \\ {y}_{t , n}\end{matrix} ) = {r}_{t , n} ( \begin{matrix}sin {∅}_{t , n} \\ cos {∅}_{t , n}\end{matrix} ) + ( \begin{matrix}{x}_{o , n} \\ {y}_{o , n}\end{matrix} )$$

The intersection coordinates

$$( \begin{matrix}x \\ y\end{matrix} )$$

are obtained by equating all vector pairs with each other to solve for each vector's unique distance, ‘r_{t,n}’. For example, each vector in the pair has the

$$( \begin{matrix}{x}_{n} \\ {y}_{n}\end{matrix} )$$

values set equal to the other vector's

$$( \begin{matrix}{x}_{n} \\ {y}_{n}\end{matrix} )$$

values. This yields two equations with two unknowns that may be solved simultaneously.

The above should be read whilst noting that a vector may also be a road, vehicle path, etc. Or a fixed noise vector for stationary noisy objects with known acoustic signatures. Fixed vectors are also used to account for error when vectors pass through or near the origin of the other vector. When vectors pass near the origin, an assumed vector is used instead as angle error margins are too high to identify the source location.

The unique distances are then used in each respective vector's equation to find the intersection coordinate for the pair.

In some embodiments intersection coordinate(s) are then compared with the target region and source object parameters to identify the source location(s). This is especially useful in that it allows for data from source locating to be checked against a prediction of noise from a source having known properties, thereby to ensure that a measurement is reasonable (and in some cases to provide an indication idea of accuracy).

In some embodiments, source locations may be identified by image processing, for example, an image processing system, which is configured to identify a known form of noise producing object in image data (for example, a vehicle), and output data representative of object type, location (e.g., GPS or other coordinates) and time. Some sensors (for example, a Bionic M-112 Array) may also predict sound intensity or sound power in the direction of the sensor based on imaging processing techniques.

The source noise level prediction process is preferably executed based on inputs including: the noise source location; each sensor's location relative to the noise source location; and each sensor's noise level value. An example of this process, according to one embodiment, is provided below to obtain the source sound power level, ‘L_{w}’, from the source sound intensity level, where corrections K₁, and K₂ and so on are the corrections for geometric, source directivity, site specific, atmospheric and other propagation effects in 3-dimensional spatial coordinates.

L_{w}=Lᵢ+K₁+K₂ . . .

The source level prediction is then compared with source object parameters to review estimates of the source level and assist with noise predictions in the impacted region.

The method then includes providing an output representative of predicted point-in-time noise levels resulting from the source at one or more remote locations. This is preferably defined based on a combination of:
A noise propagation model. This model is configured to predict how noise will travel based on factors including: (i) local topography, including presence of buildings, trees, hills and the like; and (ii) known/predicted attributes of the source, for example, where these have relevance to directionality of emission and the like. In some embodiments, a simplified model is used, which accounts for generalized noise attenuation as a function of distance.
The predicted source location, as determined from the source locating process.
The predicted source noise level, as determined from the source noise level prediction process.

In some embodiments this output includes data representative of a noise level model map. For example, this may include data that provides a predicted noise level 9 value at each of a plurality of locations. An example of how this is derived is provided below.

For every noise source, ‘n’, there is a transfer function that relates the source level to a noise level at every location of interest in the target area and impacted region. This takes the following form for theoretical and empirical modelling methods with propagation parameter ‘k’. Sound Power in Watts is equal to

$$10 {( \frac{{L}_{w}}{10} )}_{{W}_{r e f}} .$$

The Sound Pressure contribution from source ‘n’ may be obtained with the following:

$$Sound {Pressure}_{x , y , z , n} = \frac{Sound {Power}_{n}}{{k}_{x , y , z , n}}$$

Where k_{x,y,z,n} is the matrix

k_{x,y,z,n}=k_{1,x,y,z,n}k_{2,x,y,z,n}k_{3,x,y,z,n} . . .

And k₁, k₂ and k₃ and so on are the corrections for geometric, directivity, site specific, atmospheric and other propagation effects in 3-dimensional spatial coordinates

$$( \begin{matrix}x \\ y \\ z\end{matrix} ) .$$

Total Sound Pressure for all locations is obtained by summing the contribution values of Sound Pressure_{x,y,z,n} from all noise sources to produce the matrix

Sound Pressure_{x,y,z}

This may be converted to Sound Pressure at point, ‘P’, by entering the coordinates of ‘P’.

Sound Pressure_{Px,Py,Pz}

And Sound Pressure Level in decibels is obtained from the following at that point

$${L}_{p , Px , Py , P z} = 10 {log}_{10} ( \frac{Sound {Pressure}_{P x , P y , P z}}{Pref} )$$

In some embodiments the data representative of a noise level model map is rendered as a graphical object. For example, this may include a graphical object, which graphically identifies regions having similar predicted noise level values, and hence may resemble a topographic map, heat map, or the like.

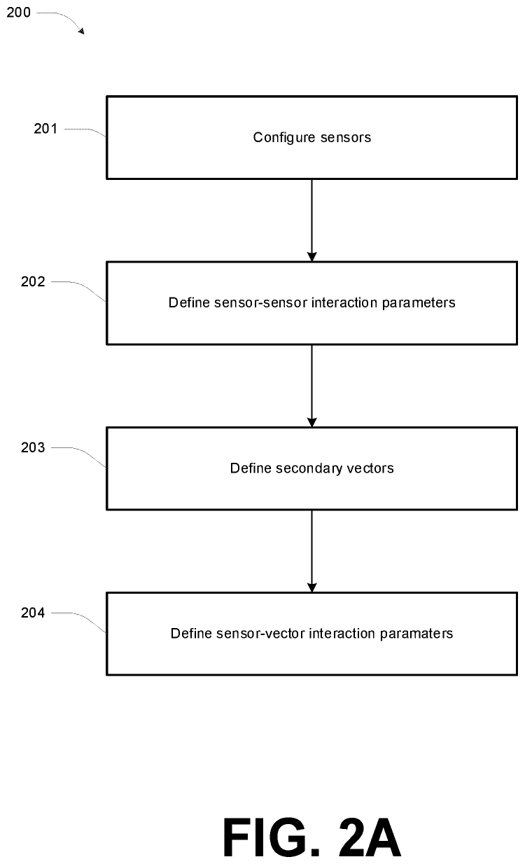

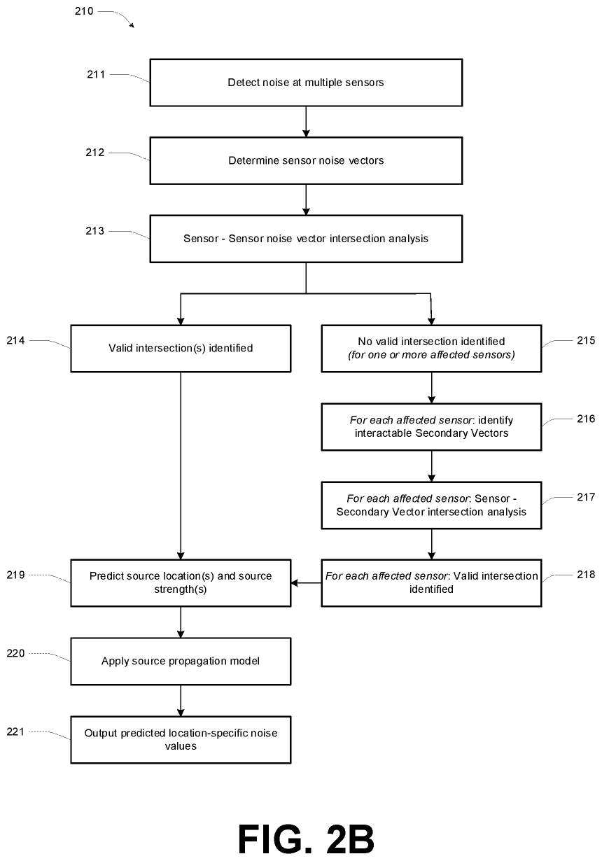

A further embodiment is described below, by reference to the method illustrated in FIG. 2A and FIG. 2B. This method may be performed via software execution via a system as described further above, or via an alternate computing system. This provides another example method for analyzing noise emissions in a target region. Once again, this method includes:

(i) Receiving data representative of noise readings measured by a plurality of directional noise sensor devices. Each of the sensor devices has a known location and orientation. The known locations are defined with respect to a predefined schema for spatial coordinates (which may be defined by a global schema, for example, latitude/longitude or GPS, and/or a local schema defined based on a local origin point).

(ii) Processing the data representative of noise readings measured by the plurality of directional noise sensor devices thereby to define a plurality of point-in-time data sets. Each point-in-time data set includes point-in time values for each of the directional noise sensor devices at a defined point in time, each providing: (A) a noise level value; and (B) a direction value associated with the noise level value.

(iii) Executing a source analysis process in respect of each or a subset of the point-in-time data sets, the process including: a source locating sub-process thereby to predict a noise source location; and a source noise level prediction sub-process thereby to predict a source noise level. In this example, the source analysis process is able to detect multiple concurrent sources.

(iv) For each of the point-in-time data sets for which the source analysis process is executed, providing an output representative of predicted point-in-time noise levels resulting from the source at one or more remote locations based on: (A) a noise propagation model; (B) the predicted source location; and (C) the predicted source noise level.

Additional detail is provided below.

FIG. 2 illustrates a configuration method 200. Block 201 represents a sensor configuration process, whereby each sensor is installed and calibrated to a predefined orientation (for example, north). Location data is recorded for each sensor, preferably including both two-dimensional location and three-dimensional location (i.e., including height above a define datum). The configuration process may additionally include a process whereby controlled sounds are emitted at a base of each sensor, thereby to enable defining of sensor-sensor vectors. The sensor-sensor vectors may be used to assist in source location prediction where the source is substantially along a sensor-sensor vector. More specifically, each directional noise signal provided by a sensor defines a vector. The intersection between two or more of those vectors provides a prediction of source location.

Block 202 represents defining sensor-sensor interaction parameters. These are used to in effect define monitoring zones, which are monitored by all or a subset of sensors. For example, an example zone ZONE A is defined having three sensors S_{A}, S_{B} and S_{C}. Interaction parameters are defined based on location observed conditions, to distinguish between: (i) sensor-sensor pairs for which a vector intersection is useful for predicting source location; and (ii) sensor-sensor pairs for which a vector intersection is not useful for predicting source location. For example, a sensor category may fall into the latter category where there is a large building or other obstruction between two given sensors. For the sake of example, assume the sensor interaction parameters define that, for ZONE A, sensor-sensor pairs (S_{A}, S_{B}) and (S_{A}, S_{C}) are defined as “intersectable,” and sensor-sensor pair (S_{B}, S_{C}) is defined as “non-intersectable.”

Block 203 represents a process including defining secondary vectors. Secondary vectors are used to describe locations within the zone in which noises are predicted as being likely to originate. For example, secondary vectors may be defined to describe roads, machinery/equipment locations, and the like. Secondary vectors are in this example used as a secondary means for predicting a source location where the intersection of sensor vectors is unsuitable. For example, in practice this may occur where there are multiple noise sources. Secondary vectors are used to allow for intersection-based source prediction using a single sensor (in combination with a secondary vector).

In a preferred embodiment, each secondary vector is defined by an origin (defined relative to the same coordinate schema used to describe sensor locations) a maximum and minimum radius, and an orientation. For the purposes of this example, assume that three secondary vectors are defined: V_{A}, V_{B} and V_{C}.

Block 204 represents defining sensor interaction parameters. Similarly to sensor-sensor interactions, these are defined based on location observed conditions, to distinguish between: (i) sensor-vector pairs for which a vector intersection is useful for predicting source location; and (ii) sensor-vector pairs for which a vector intersection is not useful for predicting source location. For example, secondary vectors: V_{A}, V_{B} and V_{C} may describe a road that passes close to sensor S_{C}, and only the pairs (S_{C}, V_{A}), (S_{C}, V_{B}), and (S_{C}, V_{C}) are defined as intersectable (with the remaining combinations being defined as non-intersectable).

FIG. 2B illustrates an example prediction method 210, using a system as configured as described by reference to FIG. 2A. For the purpose explanation, the same set of sensors (S_{A}, S_{B} and S_{C}) and vectors (V_{A}, V_{B} and V_{C}) are used.

Block 211 represents detection of noise at multiple sensors, at corresponding times. Block 212 represents determination of sensor noise vectors for each sensor (i.e., a unique noise vector for S_{A}, S_{B} and S_{C}), each using the known origin of the sensor and a direction provided by the respective sensor noise observation.

Block 213 represents a Sensor—Sensor noise vector intersection analysis. This seeks to determine an intersection between each of the pairs of intersectable noise vectors. One or more valid intersections 214 may be found (for example, valid intersections for sensor-sensor pairs (S_{A}, S_{B}) and (S_{A}, S_{C})), which provide a prediction for a source location. However, in practice there may not be a valid intersection identified, this affecting one or more sensors. For instance, there may be a valid intersection identified for (S_{A}, S_{B}), and no valid intersection identified for (S_{A}, S_{C}). In that case, S_{C} is affected, and subjected to secondary vector intersection analysis, as described below.

For each source location defined by a valid intersection, a source location and source strength are predicted at block 219. The intersection is predicted based on the location of the intersection. The source strength prediction may be based on an averaging of noise strengths at the sensor pair, or selecting a maximum value (or other techniques).

The term “valid,” when applied to intersections, preferably indicates that one or more failsafe checks are performed. Such a failsafe check may include utilization of three-dimensional data, thereby to ensure that third-dimensions directional data is within a threshold range to be consistent with two-dimensional interaction location. In some cases three dimensional data is used to discount sensor readings earlier in the process, for example, where a noise is detected from above ground or the like.

For each affected sensor where no valid intersection was identified at block 215, block 216 represents a process of identifying interactable secondary vectors, and block 217 includes performing secondary vector intersection analysis to identify an intersection between the sensor noise vector and one of the secondary vectors. In the present example, the following sensor—secondary vector pairs are defined as intersectable: (S_{C}, V_{A}), (S_{C}, V_{B}), and (S_{C}, V_{C}). As such, block 217 includes determining whether there is an intersection between the noise vector from sensor S_{C} and each of those secondary vectors. Preferably, the secondary vectors are defined such that there is only a single intersection. That intersection is subjected to a failsafe check or checks for validity (for example, using three-dimensional data). Block 218 represents identification of a valid sensor—secondary vector pair intersection, which we will assume to be an intersection of pair (S_{C}, V_{B}).

As noted, for each source location defined by a valid intersection, a source location and source strength are predicted at block 219. The intersection is predicted based on the location of the intersection. The source strength prediction may be based on an averaging of noise strengths at the sensor pair, or selecting a maximum value (or other techniques). This is performed for sensor—secondary vector intersections as with sensor—sensor intersections.

Block 220 represents applying a source propagation model, thereby to predict, for each source, a noise strength at each/any of a plurality of further locations inside and/or outside of the zone. In some embodiments, the source propagation model uses a grid, with propagation between locations on the grid being modelled using known techniques (for example, propagation modelling software). Preferably, model outcomes for each source location are pre-calculated for a default noise strength value, thereby to decrease processing times for each detected noise. For example, a difference between a predicted noise strength at the source and the default noise strength is determined (for example, in absolute, percentage, or otherwise), and that is used to adjust the pre-calculated model outcomes for all locations, which are outputted at block 221.

In this example, there are two sources: one with a location and strength prediction from the intersection of noise vectors for (S_{A}, S_{b}), and another from the intersection of a noise vector and secondary vector for (S_{C}, V_{B}). The source propagation model calculates predicted noise levels for each of those sources across the analysis area, and provides outputs at 221.

In the present examples, vectors are considered in two-dimensional space. In further embodiments, three-dimensional vectors may be used (for example, by considering intersections of vectors in three dimensions with a predefined plane or other two dimensional surface, for example, a surface representing ground level).

In some embodiments, in the case that a noise vector for a given one of the sensors is within threshold matching range of a vector pointing directly toward another of the sensors, a tertiary source location prediction process is conducted to predict a source location. It will be appreciated that, in this case, substantial overlap of the noise vectors prevents determination of an intersection. In such cases the tertiary source location prediction process may include: (i) proximity-based prediction based on relative noise strength values; and/or (ii) three-dimensional intersection techniques; and/or (ii) secondary vector based intersection techniques as described further above. For example, in some embodiments, executing a source analysis process in respect of each or a subset of the point-in-time data sets, the process including:
(i) defining a noise vector based on the location of the noise sensor and the direction value;
(ii) determining that the noise vector is within a threshold range of alignment with a line in a two dimensional plane connecting the two directional noise sensor devices; and
(iii) predicting a location of the source of the noise reading for the point-in-time data set based upon relative noise level values at each of the two directional noise sensor devices.

It will be appreciated that the methods described above provide useful processing techniques for predicting sound levels based on analysis of directional noise sensor data. It will be further appreciated that the use of secondary vectors allows for prediction of a source location using a single directional noise sensor.

It should be appreciated that in the above description of exemplary embodiments of the present disclosure, various features of the present disclosure are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the claimed invention, and form different embodiments, as would be understood by those skilled in the art. For example, in the following claims, any of the claimed embodiments can be used in any combination.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B, which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the invention.

1. A method for analyzing noise emissions in a target region, the method including:
receiving data representative of noise readings measured by a plurality of directional noise sensor devices, wherein each of the sensor devices has a known location and orientation;
processing the data representative of noise readings measured by the plurality of directional noise sensor devices thereby to define a plurality of point-in-time data sets, wherein each point-in-time data set includes point-in time values for each of the directional noise sensor devices at a defined point in time, wherein each of the point-in time values include: (A) a noise level value; and (B) a direction value associated with the noise level value;
executing a source analysis process in respect of each or a subset of the point-in-time data sets, the process including:
(i) performing a source locating process thereby to predict a noise source location; and
(ii) performing a source noise level prediction process thereby to predict a source noise level;
for each of the point-in-time data sets for which the source analysis process is executed, providing an output representative of predicted point-in-time noise levels resulting from the source at one or more remote locations based on: (A) a noise propagation model; (B) the predicted source location; and (C) the predicted source noise level.

2. The method of claim 1, wherein the source analysis locating includes identifying a location of an intersection between a noise vector for a first one of the sensors, and noise vector for a second one of the sensors, for the point-in-time data set, wherein the predicted noise source location is derived from the location of the intersection.

3. The method of claim 1, wherein the source analysis process includes:
(i) a primary source analysis process including seeking to identify a location of an intersection between a noise vector for a first one of the sensors, and noise vector for a second one of the sensors, for the point-in-time data set, wherein in the case that a valid intersection is identified, the predicted noise source location is derived from the location of the intersection; and
(ii) a secondary source analysis process including seeking to identify a location of an intersection between a noise vector for a first one of the sensors and a predefined secondary vector, for the point-in-time data set, wherein the predefined secondary vector is representative of a pre-identified likely source region, and wherein in the case that a valid intersection is identified, the predicted noise source location is derived from the location of the intersection.

4. The method of claim 1, wherein the output includes data representative of a noise level model map, which shows predicted noise levels relative to one or more sources.

5. The method of claim 1, wherein the output includes data representative of a noise level model map, which shows predicted noise level topology for a region.

6. The method of claim 1, wherein at least a subset of the plurality of directional noise sensors are located outside of a target area in an impacted region.

7. The method of claim 6, wherein one or more of the plurality of directional noise sensors are located inside of the target area in locations proximal a known local noise source.

8. The method of claim 7, including comparing data from one or more noise sensors located inside of the target area with data from one or more noise sensors located inside of the target area thereby to identify noise events originating from outside the target area.

9. The method of claim 1, wherein the source locating process is executed based on input including the direction value for each sensor device.

10. The method of claim 1, wherein the source locating process is executed based on input including the direction value for each sensor device and the noise level value for each sensor device.

11. The method of claim 1, wherein the source noise level prediction process is executed based on inputs including: the noise source location; each sensor's location relative to the noise source location; and each sensor's noise level value.

12. The method of claim 1, wherein one or more of the noise levels are defined by noise pressure values.

13. The method of claim 1, wherein one or more of the noise levels are defined by noise intensity values.

14. A method for analyzing noise emissions in a target region, the method including:
receiving data representative of noise readings measured by a single directional noise sensor device, the sensor device having a known location and orientation;
processing the data representative of noise readings measured by noise sensor device thereby to define a plurality of point-in-time data sets, wherein each point-in-time data set includes point-in time values the directional noise sensor device at a defined point in time, wherein each of the point-in time values include: (A) a noise level value; and (B) a direction value associated with the noise level value;
executing a source analysis process in respect of each or a subset of the point-in-time data sets, the process including:
(i) defining a noise vector based on the location of the noise sensor and the direction value;
(ii) determining an intersection between the noise vector and a predefined secondary vector; and
(iii) predicting that the intersection between noise vector and the predefined secondary vector represents the source of the noise reading for the point-in-time data set.

15. The method of claim 14, wherein the predefined secondary vector is defined to describe a pre-identified likely source region.

16. The method of claim 14, wherein the predefined secondary vector is defined to describe a likely source region based on observed location-specific factors.

17. A method for analyzing noise emissions in a target region, the method including:
receiving data representative of noise readings measured by two directional noise sensor devices, the sensor devices each having a known location and orientation;
processing the data representative of noise readings measured by each noise sensor device thereby to define a plurality of point-in-time data sets, wherein each point-in-time data set includes point-in time values the directional noise sensor device at a defined point in time, wherein each of the point-in time values include: (A) a noise level value; and (B) a direction value associated with the noise level value;
executing a source analysis process in respect of each or a subset of the point-in-time data sets, the process including:
(i) defining a noise vector based on the location of the noise sensor and the direction value;
(ii) determining that the noise vector is within a threshold range of alignment with a line in a two dimensional plane connecting the two directional noise sensor devices; and
(iii) predicting a location of the source of the noise reading for the point-in-time data set based upon relative noise level values at each of the two directional noise sensor devices.
